(19) United States
(12) Patent Application Publication
(10) Pub. No.: US 2016/0025251 A1
(43) Pub. Date: Jan. 28, 2016

(54) FLEXIBLE FLUID DISCHARGE MONITOR

(71) Applicant: Akron Brass Company, Wooster, OH (US)

(72) Inventor: Adam Uhler, Sterling, OH (US)

(73) Assignee: AKRON BRASS COMPANY, Wooster, OH (US)

(21) Appl. No.: 14/807,307

(22) Filed: Jul. 23, 2015

Related U.S. Application Data
(60) Provisional application No. 62/028,483, filed on Jul. 24, 2014.

(51) Int. Cl. F16L 27/113; A62C 35/68; G01F 5/00

(52) U.S. Cl. CPC F16L 27/113; G01F 5/00; A62C 35/68

(57) ABSTRACT

One or more techniques and/or systems are disclosed for a fluid monitor system that can mitigate a number of bends/curves in the fluid way of the monitor, which can improve an amount of friction loss through the monitor, and may reduce potential turbulence of the fluid stream. A flexible member can couple a positionable outlet of the monitor to an outlet of a rotation joint coupled with the base. The flexible member can span the fluid-way across an elevation actuator, coupled with one or more supports, which may be used to adjust an elevation angle of the outlet member. The flexible member may be rotationally coupled with the base to provide for adjustment of outlet direction.

### CROSS-REFERENCE TO RELATED APPLICATIONS

This application claims priority to U.S. provisional patent application Ser. No. 62/028,483, entitled HOSE MONITOR, filed Jul. 24, 2014, the entire contents of which are incorporated herein by reference.

### BACKGROUND

A monitor can be used to direct a flow of fluid, such as water or firefighting fluid, at a desired target, typically, without the need for the constant presence of an operator. Often, monitors are mounted on mobile equipment, such as trucks, portable stations, or permanent installations. A monitor can be coupled to a fluid source, and the monitor's outlet can be directed toward the desired target. A monitor can be designed to rotate around a vertical axis to provide directional coverage; and portions of the monitor may be designed to pivot about one or more horizontal axes to provide elevation coverage. A size of the monitor, and fluid flow efficiency of the monitor, can be dictated by the type and number of rotational axes.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

An example fluid monitor may comprise a flexible member, such as a flexible fluid conduit, that is fluidly coupled with a stationary base. In this aspect, in one implementation, the flexible conduit may be manipulated by an actuator, where the actuator is coupled to actuator arms that are engaged with the base and the flexible conduit. Further, the flexible member may be coupled with an outlet of a rotation joint of the monitor, in the base. In this way, for example, the flexible conduit may rotate around a vertical axis to adjust for a direction, and the actuator may adjust an elevation of the fluid outlet by adjusting the flexible conduit. By providing a monitor that does not utilize the elevation horizontal axis couplings of typical monitors, the fluid may not need to flow through the extra elbows, thereby providing reduced friction loss and less turbulence.

In one implementation, a monitor can comprise a base configured to fluidly couple with a fluid supply. Further, an outlet member can be configured to direct fluid from an outlet portion of the monitor. Additionally, a non-articulated, first flexible fluid conduit can be fluidly coupled with an outlet end of the base at an inlet end of the first flexible fluid conduit, and can be operably coupled with the outlet member at an outlet end of the first flexible fluid conduit. An actuator can be operably coupled with the base and the outlet member, and can be configured to adjust an outlet position of the first flexible fluid conduit.

To the accomplishment of the foregoing and related ends, the following description and annexed drawings set forth certain illustrative aspects and implementations. These are indicative of but a few of the various ways in which one or more aspects may be employed. Other aspects, advantages and novel features of the disclosure will become apparent from the following detailed description when considered in conjunction with the annexed drawings.

### BRIEF DESCRIPTION OF THE DRAWINGS

What is disclosed herein may take physical form in certain parts and arrangement of parts, and will be described in detail in this specification and illustrated in the accompanying drawings which form a part hereof and wherein:

FIGS. 1A and 1B are component diagrams illustrating side views of example implementations of one or more portions of a flexible hose monitor, as described herein.

FIGS. 2A and 2B are component diagrams illustrating front and rear views of example implementations of one or more portions of one or more systems described herein.

FIG. 3 is a component diagram illustrating a top view of an example implementation of one or more portions of one or more systems described herein.

FIGS. 4A and 4B are component diagrams illustrating side views of example implementations of one or more portions of an alternate flexible hose monitor, as described herein.

FIGS. 5A and 5B are component diagrams illustrating front and rear views of example implementations of one or more portions of one or more systems described herein.

FIG. 6 is a component diagram illustrating a top view of an example implementation of one or more portions of one or more systems described herein.

FIG. 7 is a component diagram illustrating and example implementations of one or more portions of an alternate flexible hose monitor, as described herein.

FIG. 8 is a component diagram illustrating a side perspective view of an example implementation of one or more portions of one or more systems described herein.

FIG. 9 is a component diagram illustrating a side perspective view of an example implementation of one or more portions of one or more systems described herein.

FIG. 10 is a component diagram illustrating a side view of an example implementation of one or more portions of one or more systems described herein.

FIG. 11 is a component diagram illustrating a side perspective view of an example implementation of one or more portions of one or more systems described herein.

### DETAILED DESCRIPTION

The claimed subject matter is now described with reference to the drawings, wherein like reference numerals are generally used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices may be shown in block diagram form in order to facilitate describing the claimed subject matter.

A typical water monitor comprises rotation around a horizontal axis, to adjust for elevation of the fluid flow output, and rotation around a vertical axis, to adjust for the direction of the fluid flow output. One or more portions of a typical water monitor can rotate around a horizontal axis, and one or more portions can rotate around the vertical axis. Further, the outlet of the typical monitor is aligned on a same plane as the vertical axis to mitigate a rotation moment that can be created by the opposing thrust from the water exiting the monitor, which can cause the monitor to rotate around the vertical axis under operation. This alignment arrangement dictates that the typical monitor's water way needs to be curved to create a bearing axis and sealing surfaces. However, respective curves in the waterway create friction loss, which can be overcome by increased pumping capacity, or results in reduced reach of the output water stream. The addition of curves can increase the turbulence of the water stream as it exits the monitor, which can also reduce the reach of the water stream. A fluid monitor system may be devised that can mitigate the number of bends/curves in the fluid way of the monitor, which can improve an amount of friction loss through the monitor, and may reduce potential turbulence of the fluid stream.

In one implementation, an example monitor can use a flexible member (e.g., rubber or polyester hose, stainless steel braided hose, composite, etc.) to connect the positionable outlet of the monitor to an outlet (e.g., ridged) of a rotation joint of the monitor. The flexible member can span the fluid-way across an elevation actuator. In this implementation, the actuator can be positioned with one or more supports, comprising a type of exoskeleton. As an example, the exoskeleton can engage with a rotation member of the monitor. In one implementation, additional degrees of freedom may be provided for the monitor, at the ends of the flexible member (e.g., rotation, axial movement) to mitigate pinching or kinking of the hose, for example, depending upon the degree of elevation implemented for the monitor. In this implementation, in order to provide the extra degrees of freedom, a ball and seal can be disposed on respective ends of the flexible member. Further, in one implementation, on one end of the flexible member, a telescoping member, such as a sliding piston, can be disposed, which may allow the flexible member to slide in and out, for example.

In typical monitors, a horizontal axis is created in order to elevate the outlet of the monitor. Alternatively, some monitors may have two 45 degree joints that work in opposite directions to create an elevation movement. By providing a monitor that does not utilize the elevation horizontal axis, as with typical monitors, the fluid may not need to flow through the extra elbows, thereby providing reduced friction loss.

In one aspect, an exemplary fluid monitor may comprise a member (e.g., rubber or polyester hose, stainless steel braided hose, composite, etc.), such as a flexible fluid conduit, that is fluidly coupled with a stationary base. In this aspect, in one implementation, the flexible conduit may be manipulated by an actuator, where the actuator is coupled to actuator arms that are engaged with the base and the flexible conduit. Further, the flexible member may be coupled with an outlet of a rotation joint of the monitor, in the base. In this way, for example, the flexible conduit may rotate around a vertical axis to adjust for a direction, and the actuator may adjust an elevation of the fluid outlet by adjusting the flexible conduit.

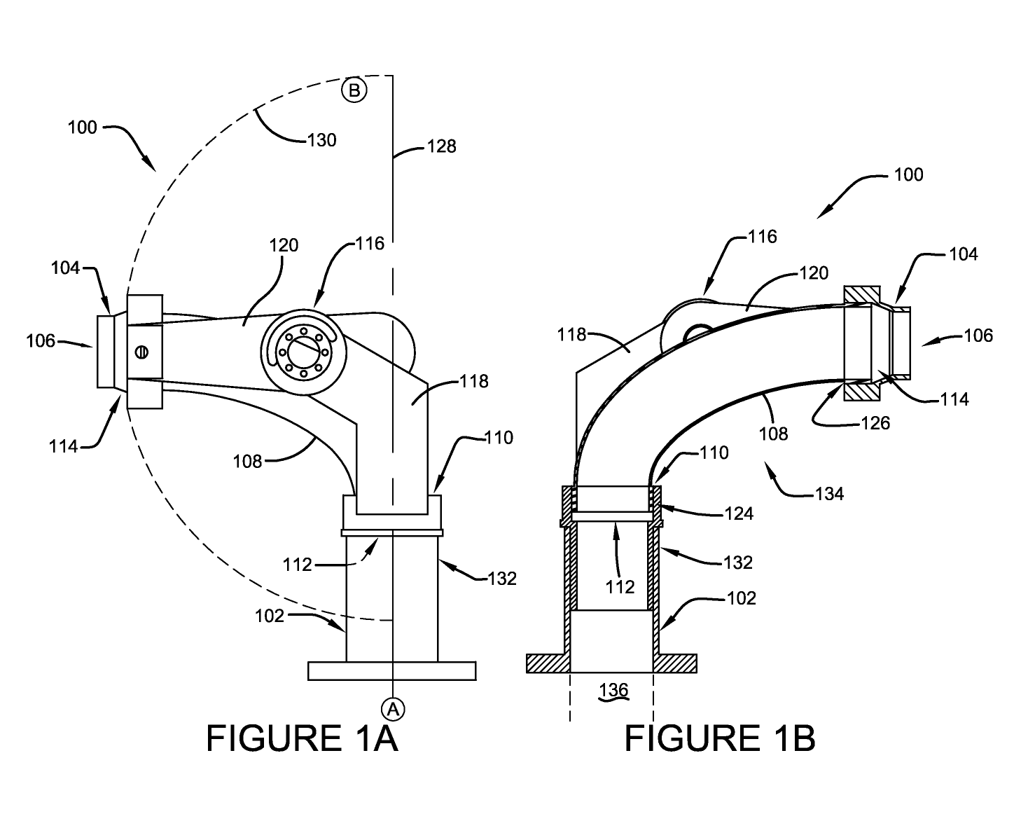

FIGS. 1A, 1B, 2A, 2B and 3 are component diagrams that illustrate one implementation of an exemplary monitor 100. In this implementation, the exemplary monitor 100 can comprise a base 102 configured to fluidly couple with a fluid supply 136. Further, an outlet member 104 can be configured to direct fluid from an outlet portion 106 of the monitor 100. Additionally, a non-articulated, first flexible fluid conduit 108 can be fluidly coupled with an outlet end 110 of the base 102 at an inlet end 112 of the first flexible fluid conduit 108. In this implementation, the first flexible fluid conduit 108 can be operably coupled with the outlet member 104 at an outlet end 114 of the first flexible fluid conduit 108. In the exemplary monitor 100, an actuator 116 can be operably coupled with the base 102 and the outlet member 104; and the actuator 116 can be configured to adjust an outlet position of the first flexible fluid conduit 108.

As an illustrative example, in this implementation, the placement of the outlet portion 106 of the monitor can determine a direction of fluid flow from the monitor 100. That is, for example, a direction of fluid flow can be adjusted by rotating the first flexible fluid conduit 108, and therefore the outlet portion 106, around an axis “A” 128 that runs through a center of the base 102. The axis “A” 128 can lie along a direction of fluid flow in the base, which may comprise a vertical axis when the base is mounted on a substantially horizontal surface (e.g., or near horizontal), for example. It should be appreciated that the term vertical axis may be used to refer to the “A” axis 128; however, the “A” axis 128 may not actually always operate, or be disposed, in a vertical orientation.

Further, for example, an elevation of the outlet portion 106 can be adjusted using the actuator 116 to move the location of the outlet member 104 along an arc “B” 130 (e.g., up and down). In this way, for example, the placement of fluid flow output from the monitor 100 can be determined by adjustment around the “A” axis 128 and/or adjustment along the “B” arc 130, using the first flexible fluid conduit 108. In this example, the flexible nature of the first flexible fluid conduit 108 may allow it to be adjusted, such that an elevation of the outlet member 104, and therefore the fluid output, can be adjusted along the “B” arc 130. In one implementation, the moment provided by the adjustment of the elevation (e.g., for outlet member 104), along the arc “B” 130, can have a point of rotation centered approximately at the actuator 116.

In one implementation, the exemplary monitor can comprise a fluid outlet component 134 that is configured to fluidly couple with the base 102 and provide an outlet for fluid from the fluid source 136. In this implementation, the fluid outlet component 134 can comprise the first flexible fluid conduit 108 and the outlet member 104. In one implementation, the first flexible fluid conduit 108 can be monolithically formed, such as from an unjointed piece of flexible material (e.g., rubber or polyester tubing, composite, etc.) to fluidly couple the positionable outlet member 104 of the monitor to the base 102. In one implementation, the flexible fluid conduit 108 can be formed from combining a plurality of pieces into a flexible structure, such as from a braided or seamed/glued material (e.g., stainless steel braided hose, seamed and formed tubing, etc.).

In one implementation, the exemplary monitor can comprise a rotation coupling 132 that couples the base 102 in rotatable engagement with the first flexible fluid conduit 108. In this implementation, for example, the rotation coupling 132 allows the first flexible fluid conduit 108 to be rotated around the “A” axis 128 (e.g., a central longitudinal axis passing through the base), such as to change direction of fluid flow from the outlet portion of the monitor 106. In another implementation, the flexible conduit 108 may couple with the base 102 in a non-rotating engagement, and the base 102 may be configured to rotate around the “A” axis 128. In this implementation, the base may comprise, or be engaged with, a rotation component that provides rotation for the base 102, resulting in rotation of the flexible conduit 108.

In one implementation, as illustrated in FIGS. 1A and 1B, the actuator 116 can be operably coupled with the base 102 using a first actuation arm 118, and the actuator 116 can be operably coupled with the outlet member 104 using a second actuation arm 120. As an example, the first actuation arm 118 may comprise a stationary arm or support when the base 102 is disposed in a stationary condition during operation. Further, in this example, the second actuation arm 120 may comprise a moveable arm that can be moved by the actuator 116 (e.g., manually and/or using artificially applied force, such as a motor), which, in turn, can move the outlet member 104 coupled with the outlet end 114 of the first flexible fluid conduit 108. In one implementation, the actuator 116 can comprise a worm gear or other type of actuation gear, pulley, motor, electro-magnetic actuator, or other actuator system, and may be used to cause the outlet member 104 to be positioned along the “B” arc of elevation. In one implementation, the actuator 116 may rotate around an axis that is orthogonal to the “A” axis 128 (e.g., a horizontal axis), providing radial rotation for the outlet member 104 along the “B” arc 130, for example, that provides a similar result as rotation around a horizontal axis of typical monitors.

As an illustrative example, the base 102 may be mounted in a stationary position, such as on a vehicle, mounting base, or ground, and coupled to a fluid source 136. In this example, activating the actuator 116 can result in radial movement of the second actuation arm 120, while the first actuation arm 118 remains stationary. The resulting radial movement of the second actuation arm 120 can cause the outlet member 104, and hence the outlet end 114 of the first flexible fluid conduit 108, to move along arc “B” 130 to adjust elevation. It should be appreciated that the first actuation arm 118 may merely comprise a connection between the actuator 116 and the base 102. That is, the actuator 116 may be disposed at the base 102, and the second actuation arm 120 may comprise a structural element disposed between the base 102 and the outlet member 104. Further, in one implementation, the first actuation arm 118 may be coupled with the base 102 in a rotating engagement, for example, such that the first actuation arm 118 is able to rotate around the “A” axis 128 when the first flexible fluid conduit 108 is rotated around the “A” axis 128. In another implementation, the first actuation arm 118 may be coupled with the base 102 in a stationary engagement, for example, such that the first actuation arm 118 rotates around the “A” axis 128 when the base 102 rotates around the “A” axis 128.

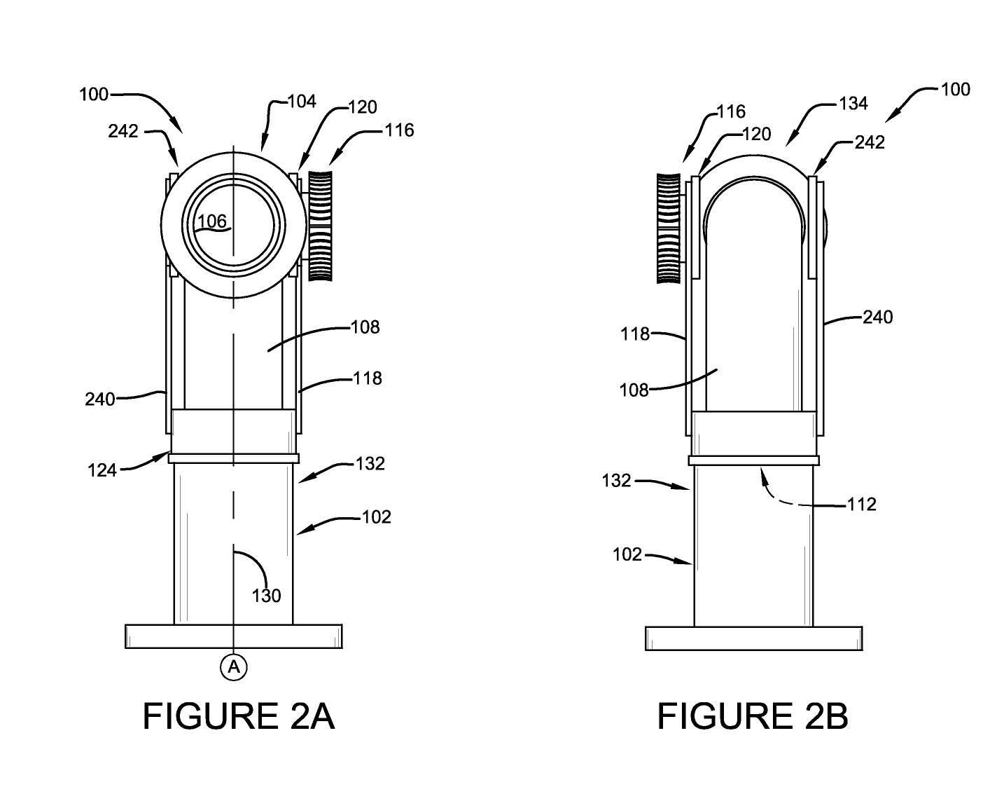

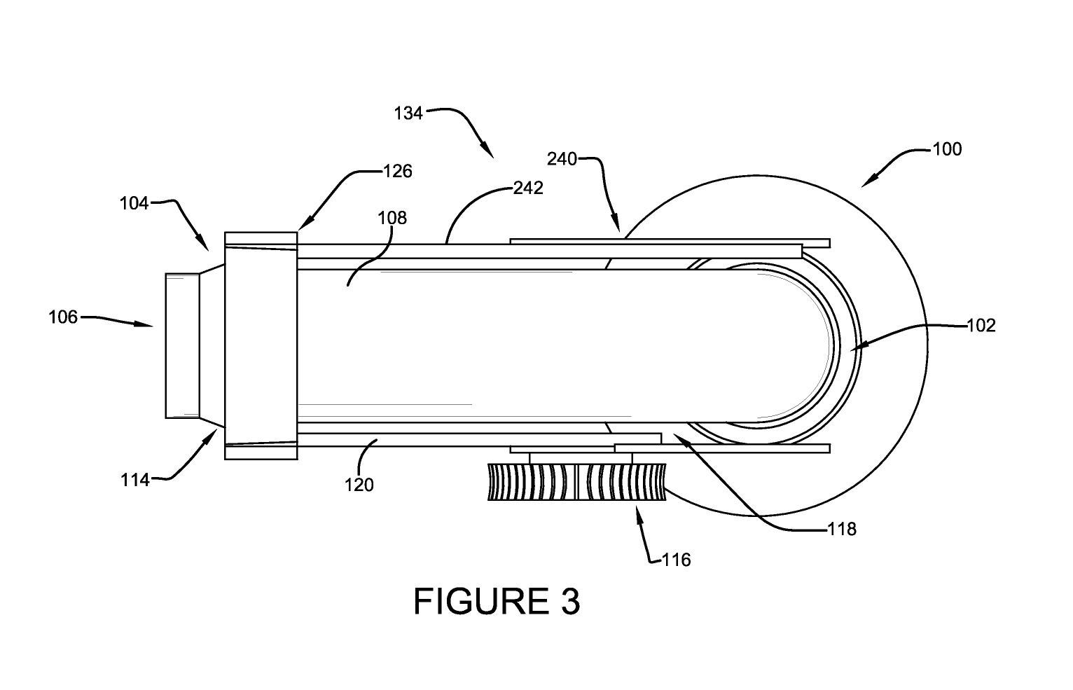

In one implementation, as illustrated in FIGS. 2A, 2B, and 3, the exemplary monitor 100 may comprise a third actuation arm 240 that can be operably coupled between the actuator 116 and the base 102. In this implementation, exemplary monitor 100 may comprise a fourth actuation arm 242 that can be operably coupled between the actuator 116 and the outlet member 104. Further, in this implementation, the first actuation arm 118 and second actuation arm 120 can be disposed on a first side of the first flexible fluid conduit 108, and the third actuation arm 240 and the fourth actuation arm 242 can disposed on a second side of the first flexible fluid conduit 108. In this way, for example, additional support may be provided for the first flexible fluid conduit 108 during operation, to mitigate the backward thrust resulting from the pressurized fluid being expelled from the outlet portion of the monitor 106. Additionally, for example, with a second set of actuation support arms 240, 242, the support arms may be configured to comprise less material, resulting in less weight for the exemplary monitor 100.

In one implementation, the outlet end of the base 102 can comprise a telescoping member 124 that is operably engaged with the inlet end 112 of the first flexible fluid conduit 108. In this implementation, the base telescoping member 124 can be configured to extend from the outlet end 110 of the base 102 during fluid flow, and can retract into the outlet end 110 of the base 102 during non-fluid flow. As an example, pressure from fluid flowing through the first flexible fluid conduit 108 can result in the first flexible fluid conduit 108 translating in the direction of fluid flow. In this implementation, in this example, the base telescoping engagement 124 allows the inlet end 112 of the first flexible fluid conduit 108 to telescope (e.g., slide) a desired distance out of the outlet end 110 of the base 102.

In one implementation, the desired distance can be determined by a stop engaged with the inlet end 112 of the first flexible fluid conduit 108 that engages with a stop engaged with the outlet end 110 of the base 102. In this way, for example, during fluid flow, the first flexible fluid conduit 108 can extend out of the base 102 at least until the conduit stop meets the base stop. Further, in this example, when fluid flow is terminated, the first flexible fluid conduit 108 can retract back into the base 102. As an example, the base telescoping engagement 124 may comprise the fluid conduit stop, the base extension stop, and a base retraction stop. In this example, the desired distance of travel for the telescoping engagement 124 may comprise a distance between the fluid conduit stop and the base extension stop.

In one implementation, the outlet member 104 can comprise a telescoping engagement 126 with the outlet end 114 of the first flexible fluid conduit 108. In this implementation, the conduit outlet telescoping engagement 126 can be configured to allow the outlet member 104 to extend from the outlet end 114 of the first flexible fluid conduit 108 during fluid flow; and can be configured to allow the outlet member 104 to retract toward the outlet end 114 of the first flexible fluid conduit 108 during non-fluid flow. As an example, during fluid flow, pressurized fluid can cause the outlet member 104 to telescope out from the outlet end 114 of first flexible fluid conduit 108, using the conduit outlet telescoping engagement 126. Further, in this example, in the absence of the pressurized fluid, when fluid flow is terminated, the outlet member 104 can retract back to the outlet end 114 of first flexible fluid conduit 108.

In one aspect, in accordance with the apparatuses and systems described herein, an example monitor can comprise a flexible component, a monitor base, and actuator component, one or more swivels comprising one or more ball components, which may swivel and adjust in complimentary sockets. In one implementation, in this aspect, the flexible member threshold limit on a curve radius of the flexible member, which may designate a failure (e.g., kink, disruptions, etc.) limit for the flexible member. For example, a small threshold radius may result in a large monitor, or may limit a radial elevation along the elevation arc (e.g., horizontal axis), which can reduce the range of operation of the monitor.

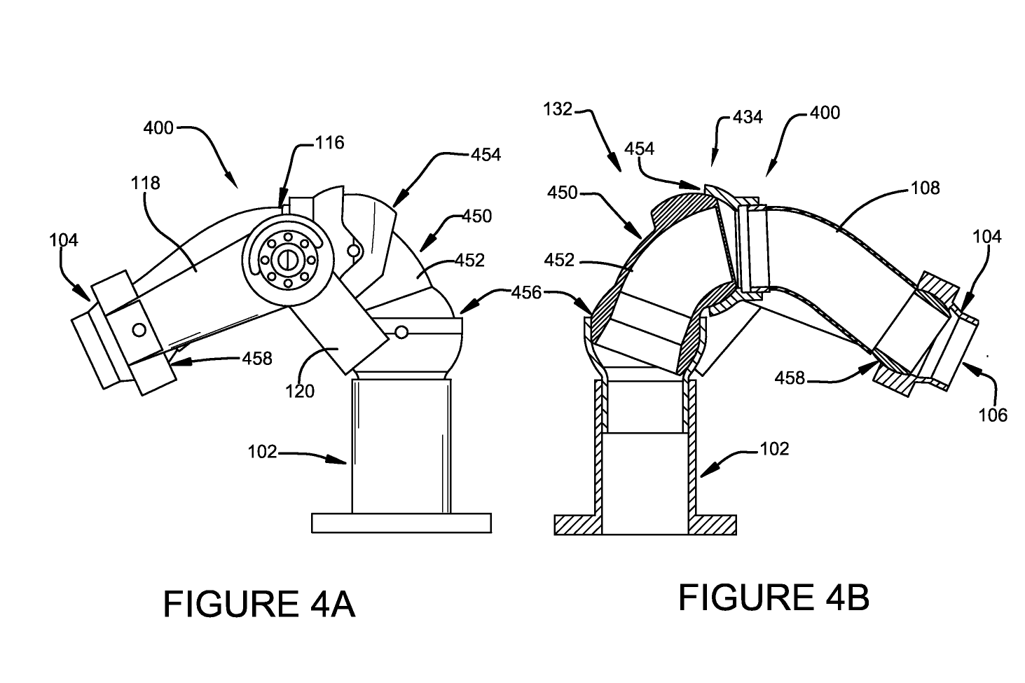

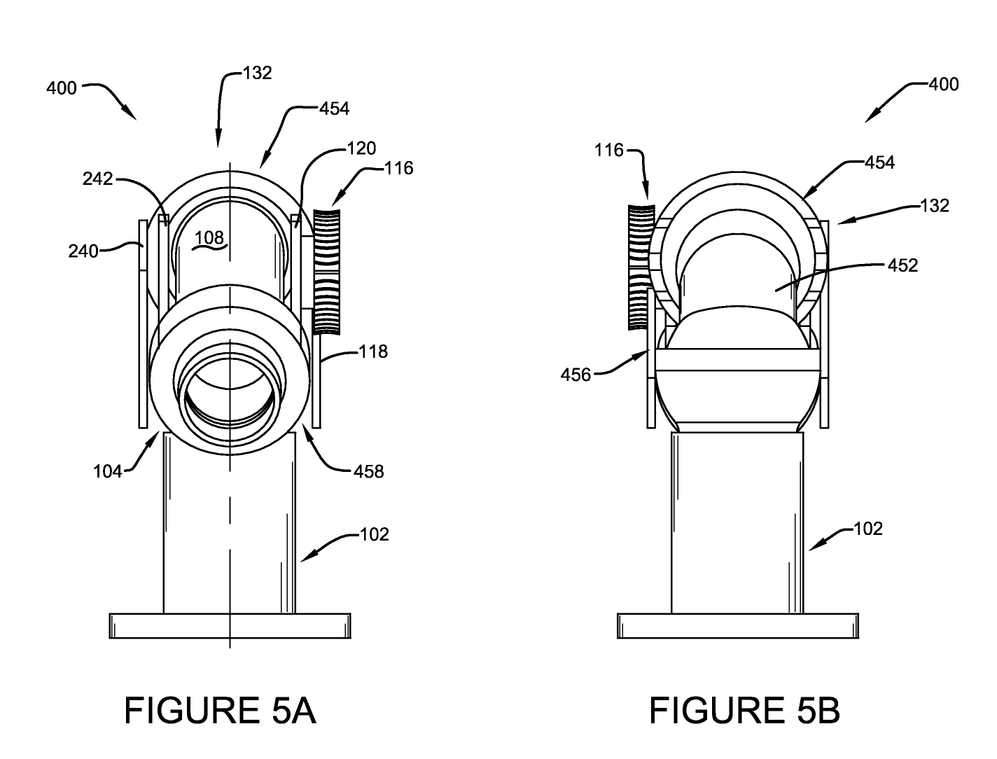

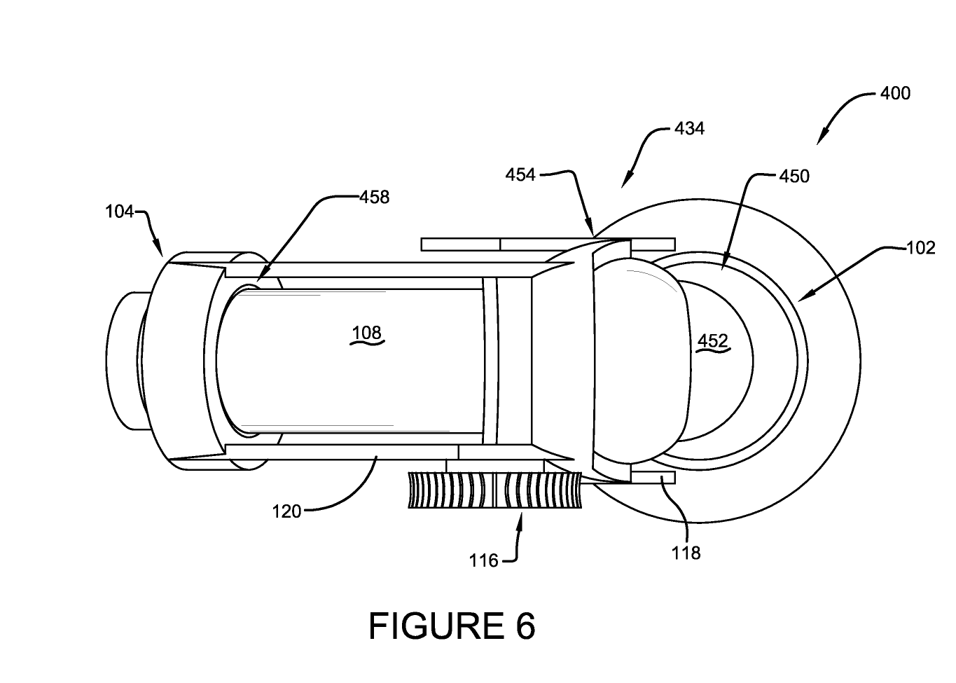

In one implementation, in this aspect, as illustrated in FIGS. 4A, 4B, 5A, 5B, and 6, an example monitor 400 can improve the elevation degrees of freedom, for example, using one or more a swiveling ball joints 456, 458 that also provide a sealing surface. As an illustrative example, the example monitor 400 may be able to provide up to an additional, approximately twenty degrees of elevation angle.

In this implementation, the example monitor 400 can comprise the base 102, the outlet member 104, and the outlet portion of the monitor 106. Further, in this implementation, the example monitor 400 can comprise an alternate fluid outlet component 434. The alternate fluid outlet component 434 can comprise the first flexible fluid conduit 108 and an alternate rotation coupling 450. The alternate rotation coupling 450 can comprise a curved conduit 450 that can be configured to provide fluid coupling between the base 102 and the first flexible fluid conduit 108. Additionally, the curved conduit 450 can comprise a ridged conduit disposed in a curved condition, for example, where the degree of radius of the curve is based at least upon a desired degree of elevation to be provided by the monitor 400.

In this implementation, the alternate rotation coupling 450 can comprise an outlet coupler 454, comprising a first ball coupling, configured to couple with the fluid outlet component 134 to provide rotation for the fluid outlet around a central, longitudinal axis of the base component 102. Further, the alternate rotation coupling 450 can comprise base coupling component 456, comprising a second ball coupling 456, configured to fluidly couple with the outlet coupler 454 in rotational engagement. In the example illustration of FIGS. 4A, 4B, 5A, 5B, and 6, a ball portion of the first ball coupling 454 and the second ball coupling 456 is disposed on respective ends of the curved conduit 450. Further, the first ball coupling 454 and the second ball coupling 456 respectively comprise a socket portion that is configured to receive the corresponding ball portion in a swivel-like engagement. For example, the swivel-like engagement of the respective first ball coupling 454 and the second ball coupling may provide for up to three-hundred and sixty degrees of rotation, and may provide a desired amount of pivoting action at respective positions around the three-hundred and sixty degree of rotation. In one implementation, desired amount of pivoting action may be based at least upon a desired degree of elevation to be provided by the monitor 400. Additionally, the respective ball couplings 452, 454 may be configured to provide a fluid seal, for example, to mitigate loss of fluid through the coupling, and may comprise a sealing component.

In one implementation, as illustrated in FIGS. 4A, 4B, 5A, 5B, and 6, the alternate fluid outlet component 434 can comprise an outlet ball coupling 458. In this implementation, the outlet ball coupling can comprise a coupling between the first flexible fluid conduit 108 and the outlet member 104. The outlet ball coupling 458 can comprise a ball portion that is disposed at the distal end of the first flexible fluid conduit 108. Further, in this implementation, the outlet ball coupling 458 can comprise a complementary socket portion disposed at the proximal end of the outlet member 104, which can be configured to receive the corresponding ball portion in a swivel-like engagement. The outlet ball coupling 458 may be configured to provide for up to three-hundred and sixty degrees of rotation, and may provide a desired amount of pivoting action at respective positions around the three-hundred and sixty degree of rotation. In one implementation, desired amount of pivoting action may be based at least upon a desired degree of elevation to be provided by the monitor 400. Additionally, the outlet ball coupling 458 may be configured to provide a fluid seal, for example, to mitigate loss of fluid through the coupling, and may comprise a sealing component.

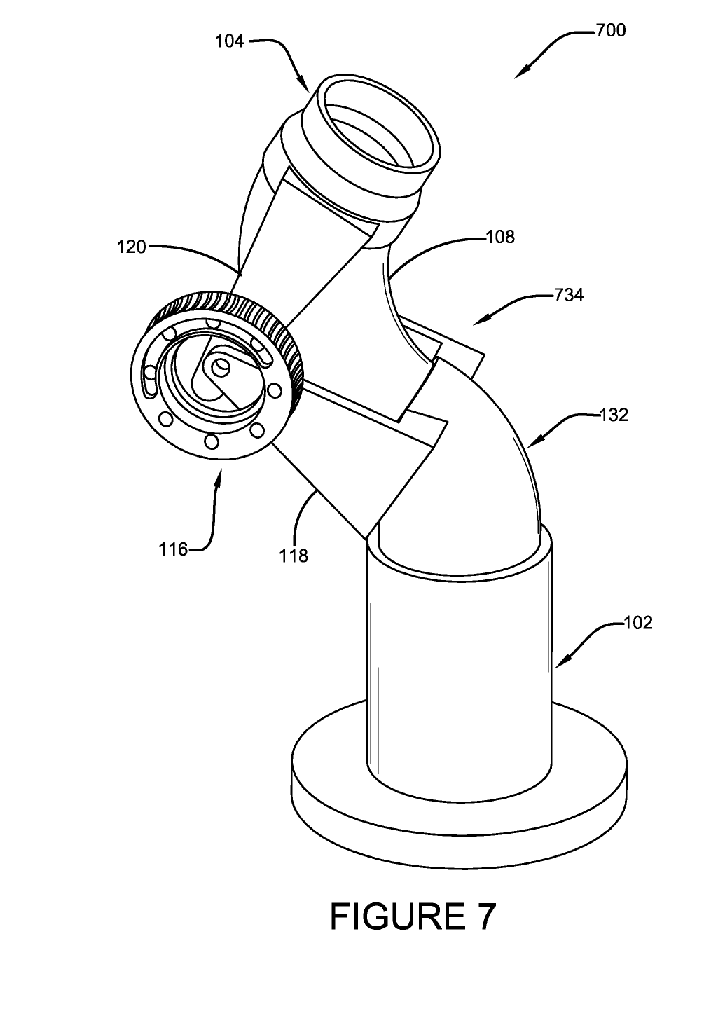

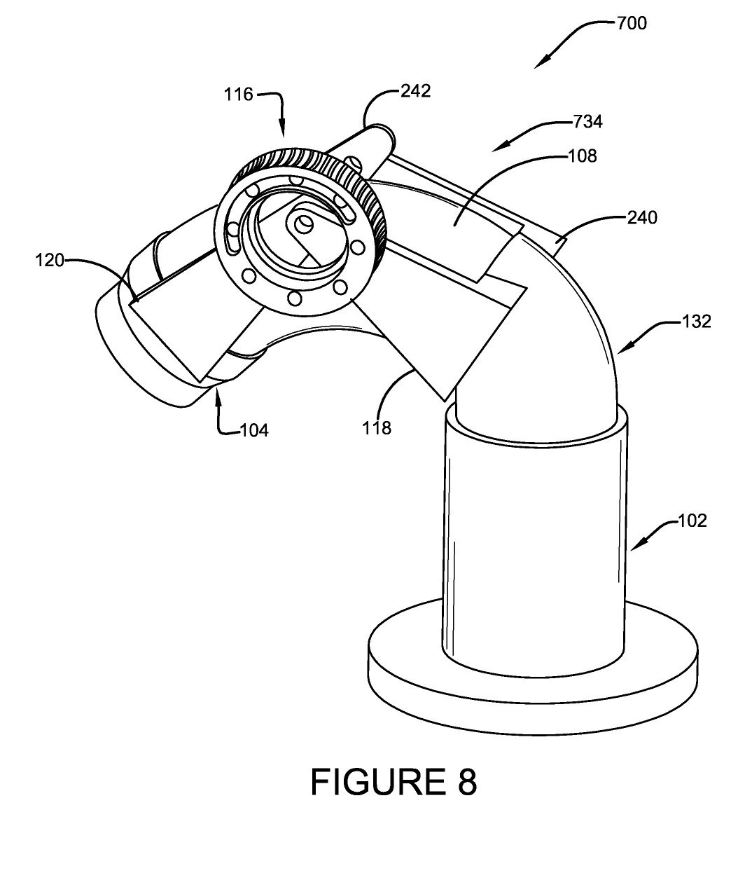

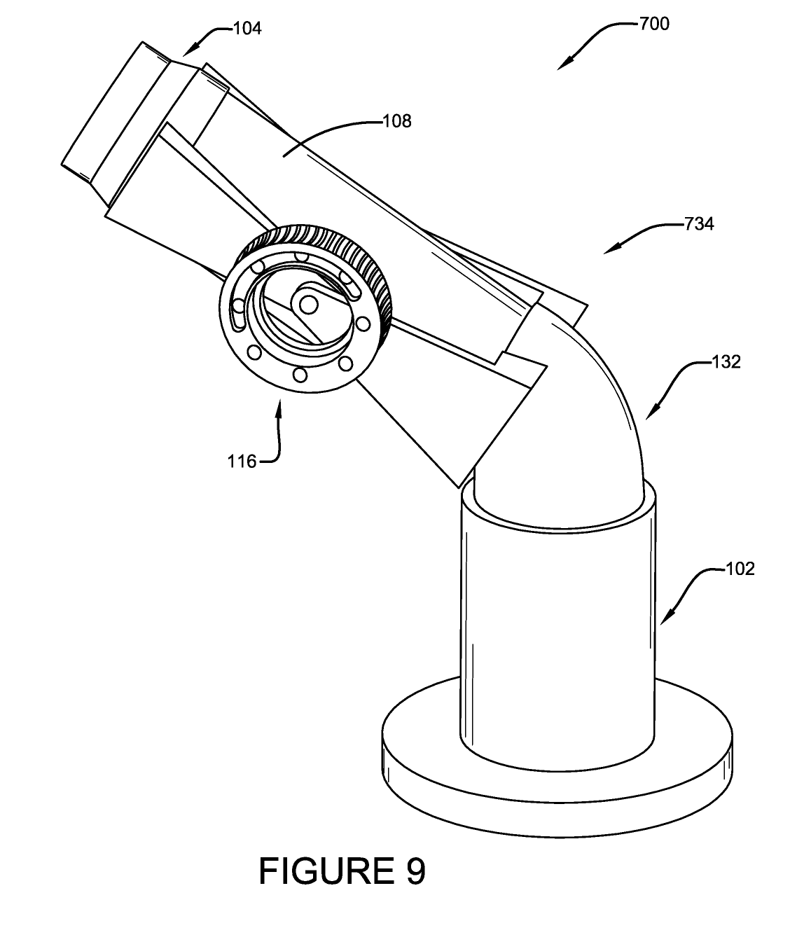

FIGS. 7, 8, 9, and 10 are component diagrams illustrating an example implementation of one or more portions of one or more systems described herein. In this implementation, an example monitor 700 comprises a base 102 and a second alternate fluid outlet component. In this implementation, the second alternate fluid outlet component can comprise a rotation coupling 132, a flexible fluid conduit 108, and an outlet member 104. Further, the example monitor 700 comprises an actuator 116, a first actuation arm 118, and a second actuation arm 120. Further, as illustrated in FIG. 8, the example alternate monitor 700 can comprise a third actuation arm 240 and a fourth actuation arm 242. As an illustrative example, FIGS. 7-9 provide examples of how the monitor 700 may be adjusted, such as by rotation around the “A” axis 128, and adjustment along the “B” arc 130, to provide various fluid outlet positions for the outlet member 104, for example, without having a horizontal adjustment component, as found in typical monitors.

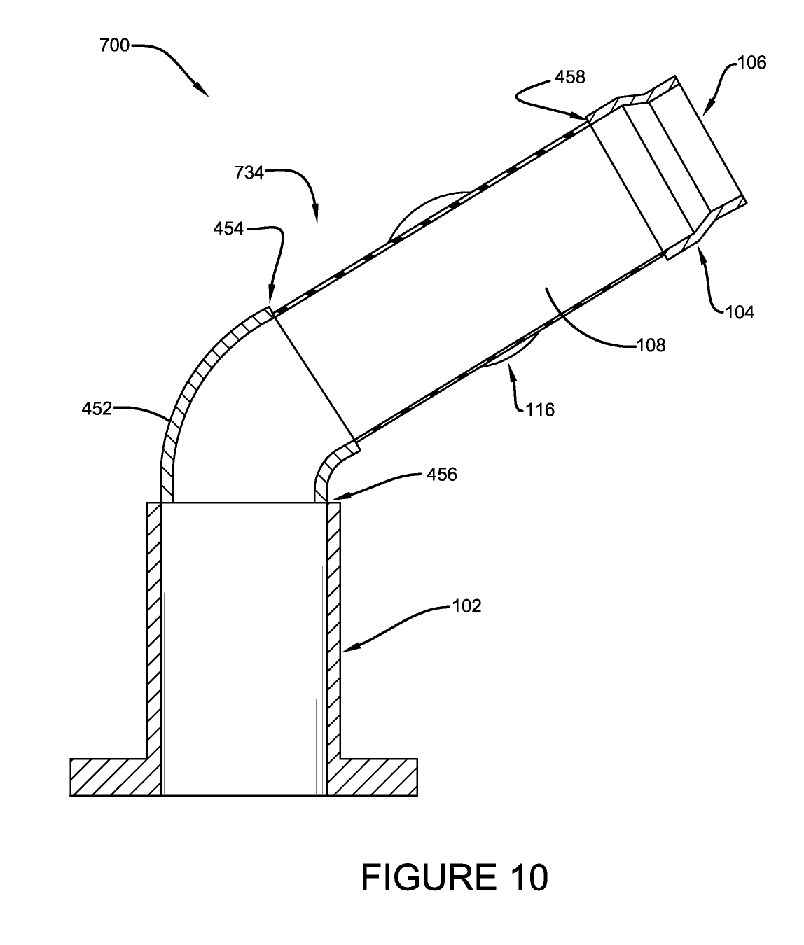

In one implementation, as illustrated in FIG. 10, the example monitor 700 can comprise the curved conduit 452, the first ball coupling 454 and the second ball coupling 456, as described above. Further, in one implementation, the example monitor 700 can comprise the outlet ball coupling 458, as described above. In this way, for example, the example monitor 700 may be provided with improved degrees of elevation adjustment, as described above.

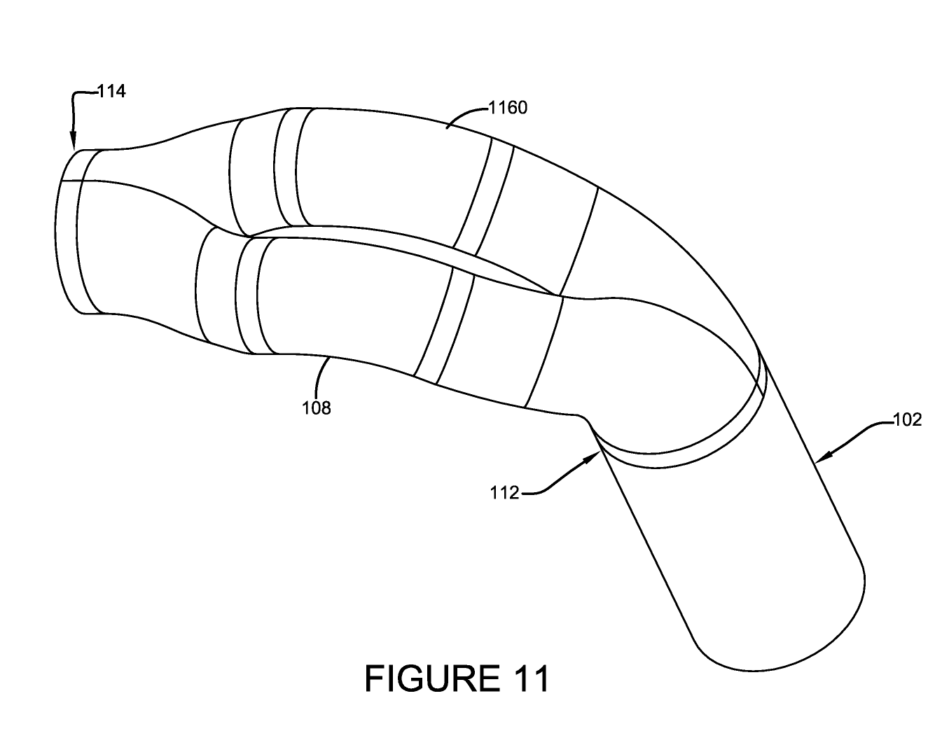

In one aspect, a monitor comprising a first flexible fluid conduit may comprise a second flexible fluid conduit. FIG. 11 is an illustration of an example implementation of at least a portion of a monitor that comprises more than one flexible fluid conduit. In this example, the first flexible fluid conduit 108 is disposed in parallel with a second flexible fluid conduit 1160, and is fluidly coupled with the base 102 and an outlet member 104. In another implementation, the second flexible fluid conduit 1160 may be disposed in parallel with the first flexible fluid conduit 108, and may be fluidly coupled with the base 102 and an inlet end 112 of the first flexible fluid conduit 108. As an example, the second flexible fluid conduit 1160 may comprise the curved conduit 452 identified in FIG. 10.

In aspect, one or more portions of one or more systems described herein may be manufactured. In one implementation, an apparatus for dispensing fluids (e.g., monitor 100, 400, 700) may be manufactured by coupling a base component (e.g., 102) that is configured to fluidly couple with a fluid source (e.g., 136), with a fluid outlet component (e.g., 134) that is configured to fluidly couple with the base and provide an outlet for fluid from the fluid source. In one implementation, the fluid outlet can comprise a non-articulated, flexible fluid conduit (e.g., 108) that is fluidly coupled with the base component, and can be configured to flexibly adjust the fluid outlet component to a plurality of outlet positions. Further, in this implementation, the an actuator (e.g., 116) can be operably coupled with the base component, where the actuator may be configured to adjust the outlet position of the fluid outlet component. Additionally, in this implementation, the actuator can be operably coupled with the fluid outlet component. In one implementation, the coupling of the base component with a fluid outlet component can comprise coupling the fluid outlet component in rotational engagement with the base component, such that the fluid outlet component can rotate around a central, longitudinal axis of the base component.

The word “exemplary” is used herein to mean serving as an example, instance or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Further, at least one of A and B and/or the like generally means A or B or both A and B. In addition, the articles “a” and “an” as used in this application and the appended claims may generally be construed to mean “one or more” unless specified otherwise or clear from context to be directed to a singular form.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. Reference throughout this specification to “one embodiment” or “an embodiment” means that a particular feature, structure, or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments. Of course, those skilled in the art will recognize many modifications may be made to this configuration without departing from the scope or spirit of the claimed subject matter.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure.

In addition, while a particular feature of the disclosure may have been disclosed with respect to only one of several implementations, such feature may be combined with one or more other features of the other implementations as may be desired and advantageous for any given or particular application. Furthermore, to the extent that the terms “includes,” “having,” “has,” “with,” or variants thereof are used in either the detailed description or the claims, such terms are intended to be inclusive in a manner similar to the term “comprising.”

What is claimed is:

1. A monitor, comprising:
a base configured to fluidly couple with a fluid supply;
an outlet member configured to direct fluid from the monitor;
a non-articulated, first flexible fluid conduit fluidly coupled with an outlet end of the base at an inlet end of the first flexible fluid conduit, and operably coupled with the outlet member at an outlet end of the first flexible fluid conduit; and
an actuator operably coupled with the base and the outlet member, and configured to adjust an outlet position of the first flexible fluid conduit.

2. The monitor of claim 1, the first flexible fluid conduit configured to allow the actuator to adjust an elevation angle of the outlet member.

3. The monitor of claim 1, the first flexible fluid conduit comprising a monolithic formation of flexible material.

4. The monitor of claim 1, comprising a second flexible fluid conduit.

5. The monitor of claim 4, the second flexible fluid conduit disposed in one or more of:
parallel with the first flexible fluid conduit, fluidly coupled with the base and the outlet member; and
series with first flexible fluid conduit, fluidly coupled with the base and the inlet end of the first flexible fluid conduit.

6. The monitor of claim 1, the actuator operably coupled with the base using a first actuation arm, and the actuator operably coupled with the outlet member using a second actuation arm.

7. The monitor of claim 6, comprising a third actuation arm operably coupled with the base, and comprising a fourth actuation arm operably coupled with the outlet member, the first actuation arm and second actuation arm disposed on a first side of the first flexible fluid conduit, and the third actuation arm and fourth actuation arm disposed on a second side of the first flexible fluid conduit.

8. The monitor of claim 1, the outlet end of the base comprising a telescoping member operably engaged with the inlet end of the first flexible fluid conduit, and configured to extend from the outlet end of the base during fluid flow, and retract into the outlet end of the base during non-fluid flow.

9. The monitor of claim 1, the outlet member comprising a telescoping engagement with the outlet end of the first flexible fluid conduit, and configured to allow the outlet member to extend from the outlet end of the first flexible fluid conduit during fluid flow, and retract toward the outlet end of the first flexible fluid conduit during non-fluid flow.

10. The monitor of claim 1, the outlet member comprising an outlet ball coupling engagement with the outlet end of the first flexible fluid conduit.

11. The monitor of claim 1, the base comprising a rotation coupling with the inlet end of the first flexible fluid conduit, the coupling configured to provide for rotation of the first flexible fluid conduit around a central longitudinal axis passing through the base.

12. The monitor of claim 11, the rotation coupling comprising:
a curved conduit; and
at least one ball coupling configured to fluidly couple with the first flexible fluid conduit.

13. An apparatus for dispensing fluid, comprising:
a base component configured to fluidly couple with a fluid source;
the fluid outlet component configured to fluidly couple with the base and provide an outlet for fluid from the fluid source, the fluid outlet comprising a non-articulated, flexible fluid conduit fluidly coupled with the base component, and configured to flexibly adjust the fluid outlet component to a plurality of outlet positions; and
an actuator operably coupled with the base component and the fluid outlet component, and configured to adjust the outlet position of the fluid outlet component.

14. The apparatus of claim 13, the base component comprising an outlet coupler configured to couple with the fluid outlet component to provide rotation for the fluid outlet around a central, longitudinal axis of the base component.

15. The apparatus of claim 14, the fluid outlet component comprising a base coupler configured to fluidly couple with the outlet coupler in rotational engagement.

16. The apparatus of claim 15, the outlet coupler coupled with the base coupler in a telescoping engagement, providing for the fluid outlet component extending in a direction of fluid flow during fluid flow, and retracting back toward the base during non-fluid flow.

17. The apparatus of claim 13, the fluid outlet component comprising an outlet member configured to direct the fluid from the outlet component.

18. The apparatus of claim 13, the flexible fluid conduit comprising a first conduit and a second conduit, the first conduit and second conduit disposed in parallel between a flexible fluid conduit inlet and outlet.

19. A method of manufacturing an apparatus for dispensing fluids, comprising:
coupling a base component, configured to fluidly couple with a fluid source, with a fluid outlet component, configured to fluidly couple with the base and provide an outlet for fluid from the fluid source, the fluid outlet comprising a non-articulated, flexible fluid conduit fluidly coupled with the base component, and configured to flexibly adjust the fluid outlet component to a plurality of outlet positions;
operably coupling an actuator, configured to adjust the outlet position of the fluid outlet component, with the base component; and
operably coupling the actuator with the fluid outlet component.

20. The method of claim 19, the coupling of the base component with a fluid outlet component comprising coupling the fluid outlet component in rotational engagement with the base component such that the fluid outlet component can rotate around a central, longitudinal axis of the base component.
